(19) United States
(12) Patent Application Publication
(10) Pub. No.: US 2026/0070411 A1
(43) Pub. Date: Mar. 12, 2026

(54) LIGHT INTENSITY INDICATOR FOR WINDSHIELD WIPERS

(71) Applicant: Ford Global Technologies, LLC, Dearborn, MI (US)

(72) Inventors: Aritzahi Leyva, Melchor Ocampo (MX); Arturo Cruz, Naucalpan de Juárez (MX); Jorge Anaya, Ixtapaluca (MX)

(73) Assignee: Ford Global Technologies, LLC, Dearborn, MI (US)

(21) Appl. No.: 18/883,027

(22) Filed: Sep. 12, 2024

(51) Int. Cl. B60K 35/215; B60K 35/10

(52) U.S. Cl. CPC B60K 35/215; B60K 35/10; B60K 2360/126; B60K 2360/332

(57) ABSTRACT

A vehicle including a windshield, a wiper, a light-emitting diode (LED) array, and an activation mechanism is disclosed. The wiper may be configured to wipe water on the windshield when the wiper may be activated. The LED array may be configured to indicate a real-time wiper speed associated with the wiper. The activation mechanism may be configured to progressively illuminate the plurality of LEDs based on the real-time wiper speed to indicate the real-time wiper speed.

### FIELD

The present disclosure relates to windshield wipers, and more specifically to a light intensity indicator for windshield wipers.

### BACKGROUND

Vehicles are equipped with windshield wipers (“wipers”) that wipe and clean the windshield when rain, snow, etc. falls on the windshield. The wipers are configured to operate at different speeds, which may be selected by a vehicle driver. Sometimes, the vehicle driver may not be aware of the real-time operating speed of the wipers or whether the wipers are turned on or off, which may lead to uncertainty and inconvenience for the driver, affecting their ability to adjust the wiper settings effectively.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example vehicle in which techniques and structures for providing the systems and methods disclosed herein may be implemented.

FIG. 2 depicts an example plurality of states associated with a light-emitting diode (LED) array in accordance with the present disclosure.

FIG. 3 depicts an example electrical diagram to control an LED array in accordance with the present disclosure.

FIG. 4 depicts a flow diagram of an example method to control an LED array in accordance with the present disclosure.

### DETAILED DESCRIPTION

### Overview

The present disclosure describes a vehicle having an indication mechanism configured to indicate/display wiper settings to a vehicle driver on a user interface. For instance, the indication mechanism may indicate whether the wipers are turned on/off. In addition, the indication mechanism may indicate the wiper speed to the vehicle driver.

In some aspects, the indication mechanism may include a horizontal light-emitting diode (LED) array in which a plurality of LEDs may be positioned side by side along a single horizontal line. In some aspects, the LED array may be disposed in a vehicle instrument cluster (or a vehicle infotainment system). In an exemplary aspect, the LED array may be disposed above a speedometer in the vehicle instrument cluster, which may provide a clear visual indication of the real-time wiper speed to the vehicle driver when the vehicle driver may be driving the vehicle or sitting in a vehicle interior portion.

In further aspects, the LED array may be communicatively coupled to a windshield wiper speed selector or a wiper switch configured to control wiper operation. In an exemplary aspect, the wiper switch may be used to activate or deactivate the wipers, and control the wiper speed (e.g., to operate the wipers at a speed desired by the vehicle driver). In some aspects, the vehicle driver may operate/adjust the wiper switch to activate/deactivate the wipers, and control the wiper speed. The wiper switch may be configured to move between a plurality of positions to control the wiper speed. The vehicle driver may set the wiper switch at a desired position, from the plurality of positions, to operate the wipers at a desired speed.

The LED array may be configured to illuminate progressively based on the wiper switch position selected/adjusted by the vehicle driver. For instance, all the LEDs may be deactivated when the wiper is turned off. When the wiper switch is set at a first position by the vehicle driver, a first LED in the LED array may be illuminated to indicate the first position to the vehicle driver; and when the wiper switch is set at a second position, the first LED and a second LED in the LED array may be illuminated to indicate the second position to the vehicle driver, and so on.

In some aspects, the vehicle may further include an activation mechanism to illuminate the LED array based on the real-time wiper switch position (or based on the real-time wiper speed). In some aspects, the activation mechanism may include a plurality of transistors that may be configured to activate the LEDs to accurately indicate the real-time wiper speed. The transistors may progressively illuminate the LEDs to indicate the wiper settings/speed to the vehicle driver. In some aspects, the LEDs may be disposed in parallel in a plurality of parallel lines. Further, each transistor may be disposed in series with an LED and a resistor. The transistor may connect a parallel line (from the plurality of parallel lines) with a preceding parallel line to progressively illuminate the LEDs in parallel, in the manner described above (e.g., illuminate both the first LED and the second LED to indicate the second position; illuminate the first LED, the second LED, and a third LED to indicate the third position of the wiper switch, and so on).

The present disclosure discloses a vehicle having a light intensity indicator (in the form of an LED array) that enhances driver's visibility of the wiper settings (e.g., in low-light or adverse weather conditions). Clear visual feedback on the wiper speed can make it easier for the vehicle drivers to adjust the wiper settings quickly and accurately. The present disclosure facilitates the vehicle driver to maintain focus on the road, when the vehicle driver may be driving the vehicle. The present disclosure provides a less complex mechanism to display the wiper settings/speed to the vehicle driver, and requires less resources.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

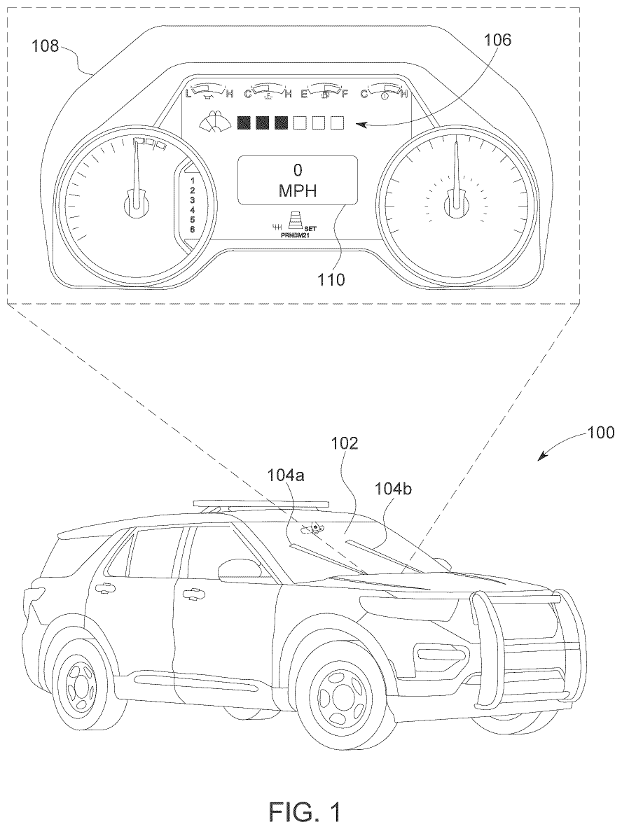

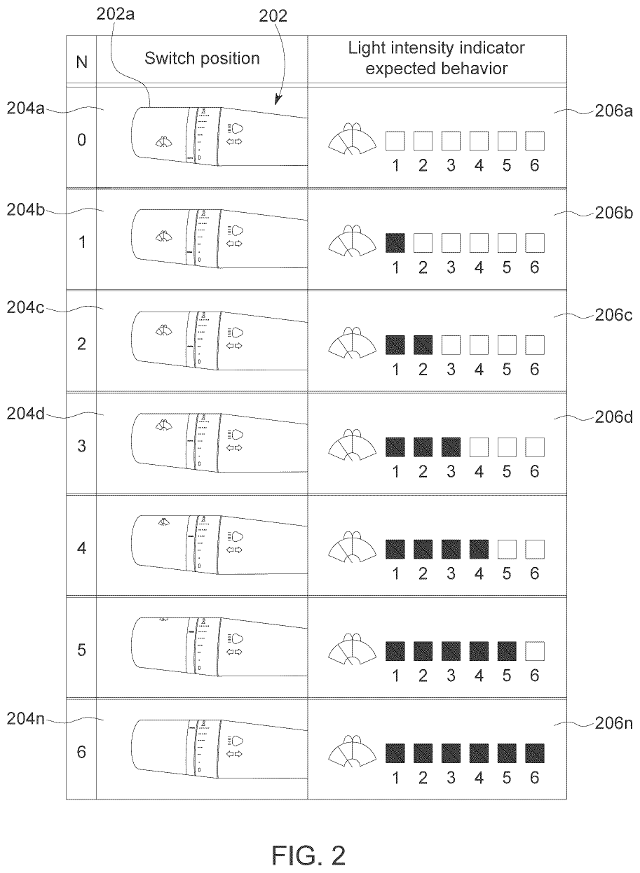

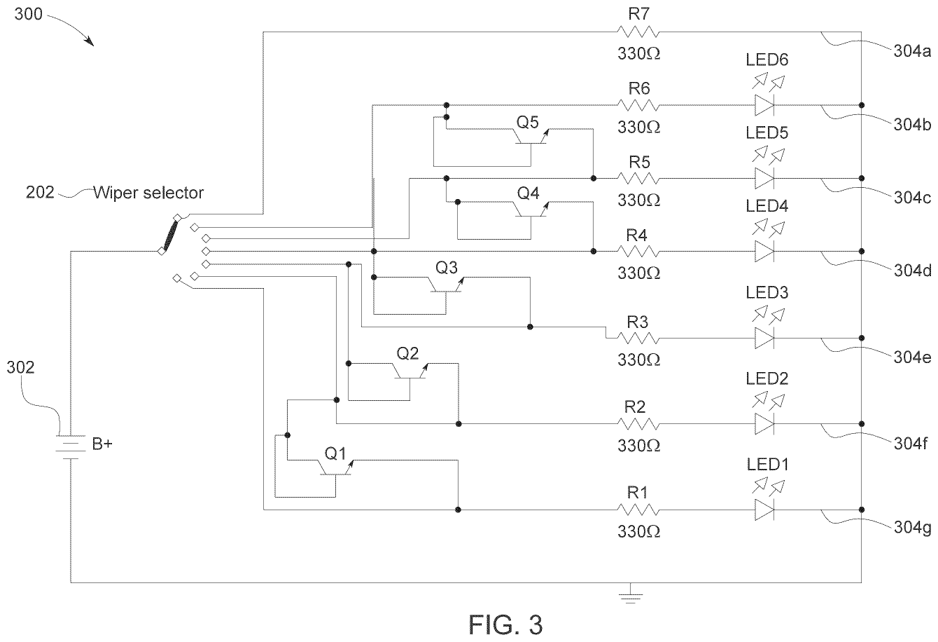

FIG. 1 depicts an example vehicle 100 in which techniques and structures for providing the systems and methods disclosed herein may be implemented. FIG. 1 will be explained in conjunction with FIGS. 2 and 3.

The vehicle 100 may take the form of any passenger or commercial vehicle such as a car, a work vehicle, a crossover vehicle, a truck, a van, a minivan, a taxi, a bus, etc. The vehicle 100 may be a manually driven vehicle or may be configured to operate in a partially/fully autonomous mode. Further, the vehicle 100 may include any powertrain such as a gasoline engine, one or more electrically-actuated motor(s), a hybrid system, etc.

The vehicle 100 may include a front windshield 102 (or windshield 102) and a back windshield (not shown). The windshield 102 and the back windshield may enable a vehicle operator/driver (not shown) sitting inside the vehicle 100 to conveniently view the area outside the vehicle 100 (e.g., road, incoming vehicles, buildings, etc.). The vehicle 100 may further include wipers 104a, 104b (collectively referred to as wipers 104) that may be configured to wipe and clean the windshield 102 when rainwater, snow, ice, dust, etc. may be present on the windshield 102. In an exemplary aspect, the first wiper 104a may be a right wiper (when viewed from inside the vehicle 100) and the second wiper 104b may be a left wiper that may be configured to wipe water from the windshield 102 when the first wiper 104a and the second wiper 104b may be activated by the vehicle 100 or a vehicle user (e.g., when rain may be falling on the windshield 102).

In some aspects, the vehicle 100 may further include a windshield wiper speed selector or a wiper switch 202 (shown in FIG. 2) that may be configured to control a wiper operation. For example, the wiper switch 202 may be used to activate or deactivate the wipers 104 (e.g., turn-on or turn-off the wipers 104). In addition, the wiper switch 202 may be used to control the wiper speed.

In some aspects, the wiper switch 202 may be used by a vehicle user/driver to operate the wipers 104 at a desired speed. The vehicle driver may operate the wiper switch 202 to activate/deactivate the wipers 104, and control the wiper speed as well (e.g., to operate the wipers 104 at the desired speed). For instance, the vehicle driver may operate the wipers 104 at a low speed when a rain speed may be less than a predefined threshold, and may operate the wipers 104 at a high speed when the rain speed may be greater than the predefined threshold, by using the wiper switch 202. In an exemplary aspect, then the wipers 104 are activated by using the wiper switch 202, an electric motor (not shown) starts. The electric motor powers a mechanical linkage that moves the wipers 104 across the windshield 102, thereby enabling the wipers 104 to clean the water on the windshield 102.

In some aspects, the wiper switch 202 may be a lever that may be mounted on a steering column. The vehicle driver may push, pull, or twist/adjust the lever to activate/operate different wiper functions (e.g., to turn-on, turn-off or change the wiper speed). In some aspects, a distal end 202a of the wiper switch 202/lever may be rotated/twisted clockwise or counter-clockwise axially to activate/operate the wipers 104. For example, the vehicle driver may rotate the distal end 202a by 15-20 degrees to turn-on the wipers 104 at a low speed, rotate by another 15-20 degrees to increase the wiper speed, rotate by another 15-20 degrees to further increase the wiper speed, and so on. The vehicle driver may similarly rotate the distal end 202a back (or in the reverse direction) to decrease the wiper speed. In further aspects, the wiper switch 202 may be dial or a knob that may be used to adjust the wiper speed.

In some aspects, the wiper switch 202 may be configured to be set at a desired position of a plurality of different positions to control the wiper operation. For example, the wiper switch 202 may be rotated/twisted by predefined angles (e.g., in steps of 15-20 degrees as described above) to move and be set at a desired position between a predefined position 0 and a predefined position N to control the wiper speed. Each position of the wiper switch 202 may result in a different rate of continuous wiper movement.

In an exemplary aspect, the wiper switch 202 may be set in seven different positions. The different positions (or “wiper switch states”) are shown in views 204a, 204b . . . 204n in FIG. 2. At a position 0, the wipers 104 may be in off state (or may be deactivated, at which the wiper speed is zero). At positions 1 and 2 (or at “starting” positions of the wiper switch 202), the wiper speed may be low; in positions 3 and 4 (or at “middle” positions), the wiper speed may be medium; and in positions 5 and 6 (or at “last” positions), the wiper speed may be high. In some aspects, at a first wiper switch position (e.g., at the position 1), the wipers 104 may move at a first wiper speed, and at a second wiper switch position (e.g., at the position 2), the wipers 104 may move at a second wiper speed. In an exemplary aspect, the second wiper speed may be greater than the first wiper speed. Similarly, at a third wiper switch position (e.g., at the position 3), the wipers 104 may move at a third wiper speed that may be greater than the second wiper speed, and so on. In some aspects, as described above, the vehicle driver may set the wiper switch 202 to the desired position (e.g., from the position 0 to the position N). When the vehicle driver selects the desired position, the wiper speed corresponding to the selected position may be adjusted.

The vehicle 100 may further include a light-emitting diode (LED) array 106 configured to indicate a real-time speed of the first wiper 104a and the second wiper 104b. The LED array 106 may be a horizontal LED array (i.e., may be aligned parallel to vehicle's bed surface or the ground surface) in which a plurality of LEDs is positioned side by side along a single horizontal line. In some aspects, the LED array 106 may be disposed in a vehicle instrument cluster 108 (or a vehicle infotainment system). In an exemplary aspect, the LED array 106 may be disposed above a speedometer 110 in the vehicle instrument cluster 108, which may provide a clear visual indication associated the real-time wiper speed to the vehicle driver when the vehicle driver may be driving the vehicle 100 or sitting in front of the vehicle instrument cluster 108.

In some aspects, the count of the LEDs in the LED array 106 may be based on a count of wiper switch positions (e.g., the count of different positions from the position 0 to the position N, or based on the number “N”). In an exemplary aspect, when there are seven wiper switch positions (e.g., position 0 to position 6, where at the position 0 the wipers 104 are in the off state) to control the wiper speed, there may be six LEDs that may be positioned in the single horizontal line in the LED array 106. This is because no LED may be separately required to indicate the position 0. When the wipers 104 are deactivated, all the LEDs may remain inactive. Thus, it may be appreciated that the count of LEDs in the LED array 106 may be equivalent to the count of wiper switch positions minus one.

The LEDs may progressively (and selectively) illuminate in parallel to indicate the real-time wiper speed. Stated another way, the LEDs may illuminate in accordance with the desired position selected by the vehicle driver. For instance, when the wiper switch 202 is at the position 0 (at which the wipers 104 are in the off state), all the LEDs are turned off or remain in a deactivated state, as shown in view 206a. When the wiper switch 202 is at the position 1, an LED 1 (e.g., a first LED from a left side in the horizontal LED array 106) may be activated or illuminated and the other LEDs (e.g., LEDs 2-6) may remain deactivated, as shown in view 206b, to indicate that the wiper switch 202 is at the position 1. When the wiper switch 202 is at the position 2, the LED 1 and an LED 2 (that may be disposed adjacent to the LED 1 towards a right side in the LED array 106) may be activated or illuminated and the other LEDs may remain deactivated, as shown in view 206c, to indicate that the wiper switch 202 is at the position 2. In this manner, when the LED 2 illuminates, the preceding LEDs (e.g., LED 1) also remain or gets illuminated.

Similarly, when the wiper switch 202 is at the position 3, the LEDs 1-3 may be illuminated, as shown in view 206d, to indicate that the wiper switch 202 is at the position 3. Stated another way, when the LED 3 illuminates, the preceding LEDs (e.g., LEDs 1-2) also remain or gets illuminated. In a similar manner, when the wiper switch 202 is at the position 6, all the LEDs 1-6 illuminate, as shown in view 206n, to indicate that the wiper switch 202 is at the position 6.

The illumination of the count of LEDs indicates the real-time wiper speed. For example, the LED array 106 may indicate that the wipers 104 may be operating at a low speed, when the LED 1 or LEDs 1-2 are illuminated. The LED array 106 may indicate that the wipers 104 may be operating at a medium speed, when the LEDs 1-3 or LEDs 1-4 may be illuminated. The LED array 106 may indicate that the wipers 104 may be operating at a fast speed, when the LEDs 1-5 or LEDs 1-6 may be illuminated.

The vehicle 100 may additionally include an activation mechanism that may be configured to progressively illuminate the LED array 106 based on the real-time wiper speed, thereby enabling the LED array 106 to indicate the real-time wiper speed to the vehicle driver. The activation mechanism may be configured to activate the LED array 106 based on a real-time position of the wiper switch 202 (e.g., progressively illuminate the LEDs as described above). For instance, the activation mechanism may deactivate all the LEDs when the wiper switch 202 may be set at the position 0 (or when the wipers 104 are turned off or having zero wiper speed). The activation mechanism may progressively illuminate the LED array 106 based on the real-time wiper speed. For example, the activation mechanism may activate the LED 1 when the wiper switch 202 may be at the position 1, activate the LEDs 1-2 when the wiper switch 202 may be at the position 2, activate the LEDs 1-3 when the wiper switch 202 may be at the position 3, and so on.

In some aspects, the activation mechanism may include an analog circuit shown in FIG. 3. Specifically, FIG. 3 depicts an electrical diagram 300 associated with the analog circuit. In some aspects, the wiper switch 202 may be part of the analog circuit/activation mechanism. In an exemplary aspect, the activation mechanism may further include a plurality of transistors (e.g., transistors Q1-Q5), as shown in FIG. 3, which may be used to perform switching (e.g., activating or deactivating) of the LEDs (e.g., LEDs 1-6) in the LED array 106 based on the real-time wiper speed or the real-time position of the wiper switch 202. In some aspects, the transistors may be Bipolar Junction Transistors (BJTs) (e.g., NPN transistors or PNP transistors), each having an emitter, a base, and a collector. The transistors may be active (e.g., enable the current to flow) when the base-emitter junction may be forward biased, and may be inactive (e.g., prevent the current flow) when the base-emitter junction may be reverse biased. In other aspects, the transistors may be Field-Effect Transistors (FETs) (e.g., N-channel and P-channel Metal-Oxide-Semiconductor FET (MOSFET)).

The transistors may be connected with the wiper switch 202, and arranged in series with the LEDs 1-6 to perform the LED switching based on the real-time wiper speed or the real-time wiper switch position, as shown in the electrical diagram 300. The electrical diagram 300 may include the wiper switch 202 that may be connected with a power supply 302 (e.g., a battery) that may be configured to selectively provide current to the LEDs 1-6, via the wiper switch 202. The electrical diagram 300 may include the LEDs 1-6 that may be connected in parallel (e.g., in parallel lines 304a, 304b, . . . 304n, collectively referred to as parallel lines 304). A count of the parallel lines 304 may be based on the count of the wiper switch positions (e.g., position 0 to position N), described above. Specifically, a count of the parallel lines 304 may be equivalent to the count of the wiper switch positions.

Each parallel lines may include one LED (except one parallel line that corresponds to the position 0 of the wiper switch 202). For instance, the parallel line 304a may be associated with the position 0, which may not include any LED. The parallel line 304g may be associated with the position 1, and may include the LED 1, as shown in the electrical diagram 300. The parallel line 304f may be associated with the position 2, and may include the LED 2. The parallel line 304e may be associated with the position 3, and may include the LED 3. The parallel line 304d may be associated with the position 4, and may include the LED 4. The parallel line 304c may be associated with the position 5, and may include the LED 5. Furthermore, the parallel line 304b may be associated with the position 6, and may include the LED 6.

The wiper switch 202 may be selectively connected to the parallel lines 304 based on the wiper switch position selected by the vehicle driver. For instance, when the wiper switch 202 is at the position 0 (e.g., when the wipers 104 are in the off state), the wiper switch 202 may be connected to the parallel line 304a. Similarly, when the wiper switch 202 is at the position 1, the wiper switch 202 may be connected to the parallel line 305g. When the wiper switch 202 is at the position 2, the wiper switch 202 may be connected to the parallel line 304f, and so on.

The transistors Q1-Q5 may be connected between the wiper switch 202 and the LEDs 1-6 to control the LED switching based on the wiper switch position (or based on the real-time wiper speed). The transistors Q1-Q5 may be connected in series with the respective LEDs. In some aspects, the LED may be powered by an emitter current. Each LED may include a positive or anode (+) terminal and a negative or cathode (−) terminal. The emitter associated with the transistor may be connected to the anode terminal to power the LED.

In some aspects, each transistor may connect a parallel line to a preceding parallel line, and control the progressive illumination of the LEDs in parallel based on the real-time wiper speed/real-time wiper switch position. For instance, the transistor Q1 connects the parallel lines 305g and 304f, the transistor Q2 connects the parallel lines 304f and 304e, the transistor Q3 connects the parallel lines 304e and 304d, the transistor Q4 connects the parallel lines 304d and 304c, and the transistor Q5 connects the parallel lines 304c and 304b.

In further aspects, the electrical diagram 300 may include a plurality of resistors (e.g., resistors R1-R7) that may be connected in series with the respective LEDs. Each parallel line 304 may include one resistor. For instance, the resistor R1 may be located in the parallel line 305g, the resistor R2 may be located in the parallel line 304f, the resistor R3 may be located in the parallel line 304e, and so on. In further aspects, each resistor may be located between the respective transistor and the LED, as shown in FIG. 3. Each transistor may be connected in series with the respective resistor. Each resistor may have any resistance. For instance, each resistor may have a resistance of 330 ohms.

In operation, when the wiper switch 202 may be positioned at the position 0 (or when the wipers 104 may be turned off or the wiper speed is equivalent to zero), the wiper switch 202 may be connected to the parallel line 304a. When the wiper switch 202 may be connected to the parallel line 304a, the current may flow through the parallel line 304a. Since the parallel line 304a does not include any LED, no LED in the LED array 106 may be illuminated. When the vehicle driver twists/adjusts the wiper switch 202 to the position 1, the wiper switch 202 may be connected to the parallel line 305g and the current may flow through the parallel line 305g. In this configuration, the current may pass through the LED 1 directly (which illuminates the LED 1), and the transistor Q1 may be in the inactive mode. Thus, in the position 1, only one LED (i.e., the LED 1) may be illuminated.

When the vehicle driver further twists the wiper switch 202 to the position 2, the wiper switch 202 may be connected to the parallel line 304f and the current may flow through the parallel line 304f (and may be disconnected from the parallel line 305g). In this configuration, the current may pass through the LED 2 directly (which illuminates the LED 2) and may pass through the LED 1 via the transistor Q1 (as the transistor Q1 may turn into the active mode when the wiper switch 202 may be connected to the parallel line 304f). Since the transistor Q1 connects the parallel lines 304f and 305g, when the current passes through the parallel line 304f, the current may enter the transistor Q1 and cause the base-emitter junction to become forward biased, which may cause the LED1 to illuminate via the emitter current associated with the transistor Q1. Thus, in the position 2, both the LEDs 1 and 2 may be illuminated. Stated another way, when the LED 2 is illuminated, the preceding LEDs (e.g., the LED 1) may also be illuminated.

Similarly, when the vehicle driver further twists the wiper switch 202 to the position 3, the wiper switch 202 may be connected to the parallel line 304e and the current may flow through the parallel line 304e (and may be disconnected from the parallel line 304f). In this configuration, the current may pass through the LED 3 directly (which illuminates the LED 3) and may pass through the LED 1 and the LED 2 via the transistor Q1 and the transistor Q2 (as the transistors Q1 and Q2 may be in the active mode when the wiper switch 202 may be connected to the parallel line 304e), for the reasons described above. Thus, in the position 3, the LEDs 1-3 may be illuminated. Stated another way, when the LED 3 may be illuminated, the preceding LEDs (e.g., the LEDs 1-2) may be illuminated. In the similar manner, the LEDs 1-4 may be illuminated when the wiper switch 202 may be positioned at the position 4, the LEDs 1-5 may be illuminated when the wiper switch 202 may be positioned at the position 5, and the LEDs 1-6 may be illuminated when the wiper switch 202 may be positioned at the position 6.

Although the present disclosure describes the activation mechanism as having the transistors, such description should not be construed as limiting. In alternative aspects (not shown), the activation mechanism may include a speed sensor and a processor that may be communicatively coupled to the speed sensor. The speed sensor may be configured to detect the real-time wiper speed. In some aspects, the speed sensor may detect the real-time wiper speed by detecting the real-time wiper switch position. The processor may be configured to obtain inputs from the speed sensor and determine the real-time wiper speed based on the inputs (e.g., when the wipers 104 may be activated). Responsive to determining the real-time wiper speed, the processor may progressively illuminate the LED array 106 in the same manner as described above.

The vehicle 100 implements and/or performs operations, as described here in the present disclosure, in accordance with the owner manual and safety guidelines. In addition, any action taken by a vehicle operator/driver based on the notifications/recommendations provided by the vehicle 100 should comply with all the rules specific to the location and operation of the vehicle 100 (e.g., Federal, state, country, city, etc.). The notifications/recommendations, as provided by the vehicle 100, should be treated as suggestions and only followed according to any rules specific to the location and operation of the vehicle 100.

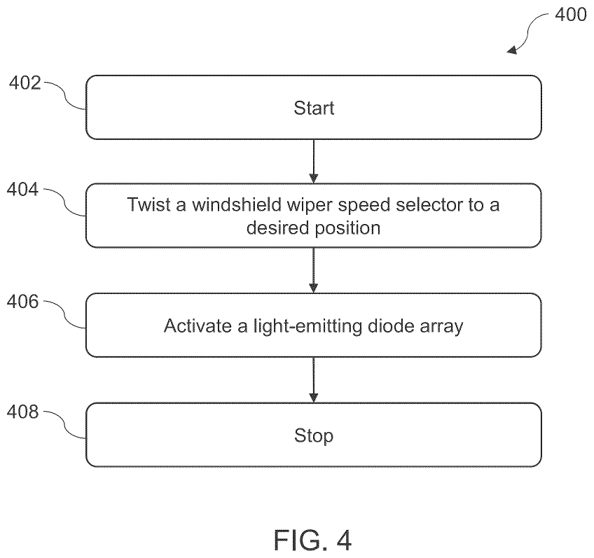

FIG. 4 depicts a flow diagram of an example method 400 to control the LED array 106 in accordance with the present disclosure. FIG. 4 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 400 starts at step 402. At step 404, the method 400 may include twisting/adjusting the windshield wiper speed selector (or the wiper switch 202) to a desired position to control the wiper speed. In some aspects, the vehicle driver may twist the wiper switch 202 to the desired position (e.g., from the position 0 to N, as described above). At step 406, the method 400 may include activating, by the activation mechanism (including the transistors Q1-Q5 described above), the LED array 106 to indicate the real-time wiper speed to the vehicle driver. The activation mechanism may be configured to progressively illuminate the LED array 106 based on the real-time wiper speed, as described above.

The method may stop at step 408.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
a windshield;
a wiper configured to wipe water on the windshield when the wiper is activated;
a light-emitting diode (LED) array comprising a plurality of LEDs configured to indicate a real-time wiper speed associated with the wiper; and
an activation mechanism configured to progressively illuminate the plurality of LEDs based on the real-time wiper speed to indicate the real-time wiper speed.

2. The vehicle of claim 1, wherein the LED array is disposed in a vehicle instrument cluster.

3. The vehicle of claim 2, wherein the LED array is disposed above a speedometer in the vehicle instrument cluster.

4. The vehicle of claim 1, wherein the LED array is a horizontal LED array in which the plurality of LEDs is positioned side by side along a single horizontal line.

5. The vehicle of claim 1, further comprising a windshield wiper speed selector configured to control the real-time wiper speed associated the wiper, and wherein the windshield wiper speed selector is configured to be set at a plurality of positions to control the real-time wiper speed.

6. The vehicle of claim 5, wherein a count of the plurality of LEDs is based on a count of the plurality of positions.

7. The vehicle of claim 5, wherein the activation mechanism is configured to activate the LED array based on a real-time position, from the plurality of positions, of the windshield wiper speed selector.

8. The vehicle of claim 7, wherein the activation mechanism comprises a plurality of transistors, and wherein the windshield wiper speed selector is selectively connected to one or more transistors, of the plurality of transistors, based on the real-time position.

9. The vehicle of claim 8, wherein the plurality of LEDs is connected in parallel in a plurality of parallel lines.

10. The vehicle of claim 9, further comprising a plurality of resistors, wherein each resistor is connected in series with a respective LED of the plurality of LEDs.

11. The vehicle of claim 9, wherein each transistor of the plurality of transistors is connected in series with a respective LED of the plurality of LEDs.

12. The vehicle of claim 11, wherein each transistor connects a parallel line, of the plurality of parallel lines, to a preceding parallel line.

13. The vehicle of claim 8, wherein the plurality of transistors is configured to progressively activate the plurality of LEDs based on the real-time wiper speed.

14. A vehicle comprising:
a windshield;
a wiper configured to wipe water on the windshield when the wiper is activated;
a light-emitting diode (LED) array comprising a plurality of LEDs configured to indicate a real-time wiper speed associated with the wiper;
a windshield wiper speed selector configured to control the real-time wiper speed associated the wiper, and wherein the windshield wiper speed selector is configured to be set at a plurality of positions to control the real-time wiper speed; and
an activation mechanism configured to progressively illuminate the plurality of LEDs based on the real-time wiper speed to indicate the real-time wiper speed,
wherein the activation mechanism comprises a plurality of transistors, and wherein the windshield wiper speed selector is selectively connected to one or more transistors, of the plurality of transistors, based on a real-time position from the plurality of positions.

15. The vehicle of claim 14, wherein the LED array is disposed in a vehicle instrument cluster.

16. The vehicle of claim 15, wherein the LED array is disposed above a speedometer in the vehicle instrument cluster.

17. The vehicle of claim 14, wherein the LED array is a horizontal LED array in which the plurality of LEDs is positioned side by side along a single horizontal line.

18. The vehicle of claim 14, wherein a count of the plurality of LEDs is based on a count of the plurality of positions.

19. The vehicle of claim 14, wherein the plurality of LEDs is connected in parallel in a plurality of parallel lines.

20. A method comprising:
adjusting a windshield wiper speed selector to a desired position to control a wiper speed associated with a wiper, wherein the wiper is configured to wipe water on a windshield of a vehicle when the wiper is activated; and
activating, by an activation mechanism, a light-emitting diode (LED) array to indicate a real-time wiper speed of the wiper, wherein the activation mechanism is configured to progressively illuminate a plurality of LEDs in the LED array based on the real-time wiper speed to indicate the real-time wiper speed.
